(19) United States
(12) Patent Application Publication
(10) Pub. No.: US 2017/0195043 A1
(43) Pub. Date: Jul. 6, 2017

(54) OPTICAL TEST PORT BASED UPON NANOCRYSTAL-IN-GLASS-MATERIAL

(71) Applicant: TYCO ELECTRONICS CORPORATION, BERWYN, PA (US)

(72) Inventors: HAIPENG ZHANG, SANTA CLARA, CA (US); SANDEEP RAZDAN, MILLBRAE, CA (US); JIBIN SUN, MOUNTAIN VIEW, CA (US); NICOLA PUGLIANO, REDWOOD CITY, CA (US)

(21) Appl. No.: 14/984,761

(22) Filed: Dec. 30, 2015

(51) Int. Cl. H04B 10/079

(52) U.S. Cl. CPC H04B 10/07957

(57) ABSTRACT

An electrochromic test port provides an actively tunable system for building an optical test port for an optical waveguide with enhanced SNR properties over conventional approaches.

### FIELD OF INVENTION

In general, the invention relates generally to optical systems and nanocrystal-in-glass materials. In more detail, the invention relates to a nanocrystal-in-glass material for providing fiber optics telecommunications functionality.

### BACKGROUND

It is critical to test the optical signal transmission characteristics of fiber optic communication lines at various points along the line. Conventional optical fiber consists of a core and a cladding and as such may be utilized as an optical waveguide.

Conventional optical test ports utilize a tapered fiber approach, which introduces some amount of optical loss for light that traverses the testing port. In particular, conventional optical test ports require mounting a certain section of the fiber such that the fiber is stretched rendering the core and cladding much thinner compared to rest of fiber. When the optical light passes through the stretched section, because the diameter of fiber is thinner in that area it results in optical loss in the propagated signal. A photodetector is introduced to measure the leakage light.

Applicants have identified significant shortcomings with conventional approaches to optical testing of waveguides. In particular, a major limitation of conventional approaches such as the tapered fiber approach, is that there is no way to turn the optical test functionality “on” or “off” in an active manner.

### SUMMARY OF INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

According to one embodiment an optical test port for testing an optical waveguide comprises a nanocrystal-in-glass member coupled to the optical waveguide, the nanocrystal-in-glass member comprising a transmission portion and a testing portion, at least one electrode coupled to the nanocrystal-in-glass member such that an optical transmission through at least one of the transmission portion and the testing portion is varied continuously based upon a voltage established on the electrode, and a photodetector coupled to the testing portion, the photodetector receiving a light signal from the testing portion and indicating a transmission characteristic of the optical waveguide.

According to an alternative embodiment, an optical test port for testing an optical waveguide comprises a nanocrystal-in-glass member coupled to the optical waveguide, a first electrode and a second electrode coupled to the nanocrystal-in-glass member and a detector coupled to the first electrode for measuring electrons generated by absorbed photons passing through the nanocrystal-in-glass member.

According to an alternative embodiment, an optical test port for testing an optical waveguide comprises a nanocrystal-in-glass member coupled to the optical waveguide, the nanocrystal-in-glass member comprising a transmission portion and a testing portion, at least one electrode coupled to the nanocrystal-in-glass member such that an optical transmission through at last one of the transmission portion and the testing portion is varied continuously based upon a voltage established on the at least one electrode, and a detector coupled to the testing portion, the detector measuring an electromagnetic property of the testing portion.

### BRIEF DESCRIPTION OF DRAWINGS

FIG. 1 depicts a cross-section of an electrochromic material structure for use in an optical test port according to one embodiment.

FIG. 2A depicts an optical test port incorporating an electrochromic material according to one embodiment.

FIG. 2B depicts an optical test port incorporating an electrochromic material in which the test port is in an “off” state according to one embodiment.

FIG. 2C depicts an optical test port incorporating an electrochromic material in which the test port is in an “on” state according to one embodiment.

FIG. 3 depicts an alternative embodiment of an optical test port incorporating an electrochromic material in which an induced photo-voltage is utilized to monitor an optical transmission characteristic according to one embodiment.

FIG. 4 depicts an optical test port incorporating an electrochromic material that combines a splitting structure and an induced photo-voltage measuring approach according to one embodiment.

### DETAILED DESCRIPTION

Applicants have developed a technique that allows for active tuning of optical test ports and makes use of electrochromic materials, which may be optically tuned by an applied electric field. The optical test port is arranged to include a transmission portion and a testing portion, both of which are comprised of electrochromic materials. If testing is desired, a voltage signal may be applied to the electrochromic material associated with the testing portion to cause a portion of the light to propagate through the testing portion. If no testing is desired, no voltage is applied so that all of optical signal will pass through the transmission portion with a minimum of optical loss and interruption to optical transmission line.

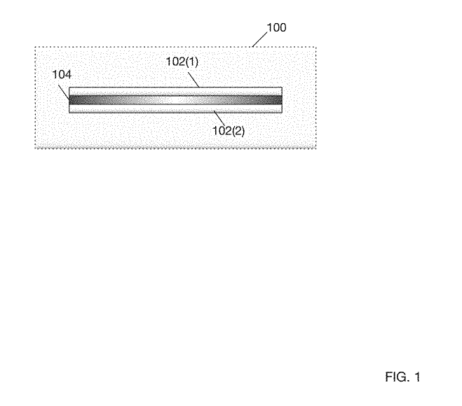

FIG. 1 depicts a cross-section of an electrochromic material structure 100 for use in an optical test port according to one embodiment. According to one embodiment, electrochromic material structure 100 comprises electrode 102(1), electrode 102(2) and a nanocrystal-in-glass material 104. According to one embodiment electrochromic material structure 100 incorporates a nanocrystal-in-glass material. According to alternative embodiments, an electro-optic material such as a semiconductor material (i.e., gallium arsenide or lithium niobate) may also be used to control light transmission via an applied voltage. Other materials may be substituted so long as their optical transmission properties may be varied based upon application of a control signal.

For example, light transmission properties of nanocrystal-in-glass material 104 may be modulated by application of a voltage to nanocrystal-in-glass material 104 via electrodes 102(1) and 102(2), which form a pair. The voltage applied may be obtained from a voltage source and vary over a range. Nanocrystal-in-glass material 104 may incorporate nanocrystals covalently bonded in amorphous material and may enable dynamic control of near-infrared and visible light transmission depending upon an applied voltage to the material.

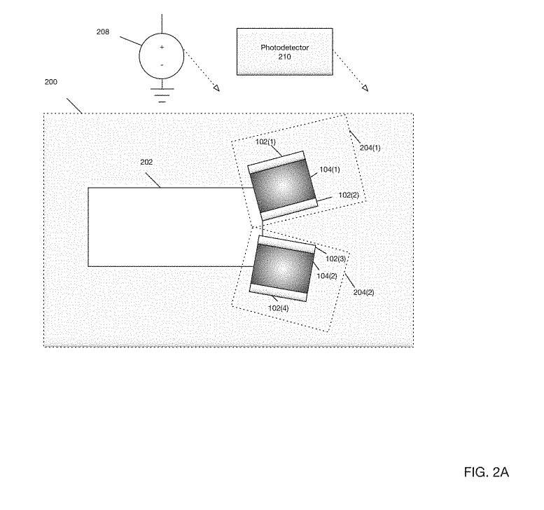

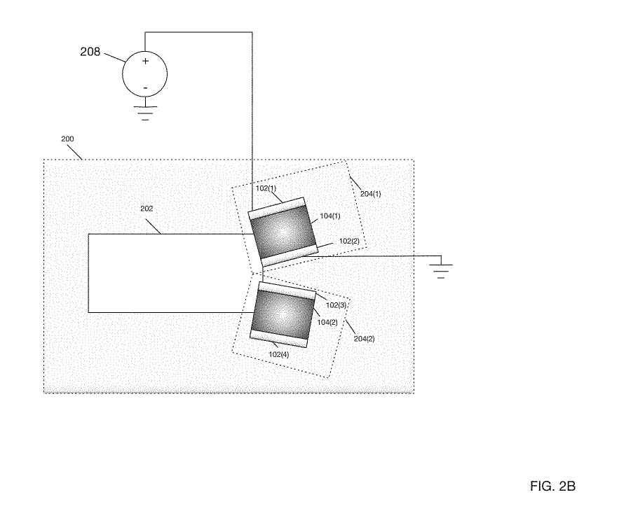

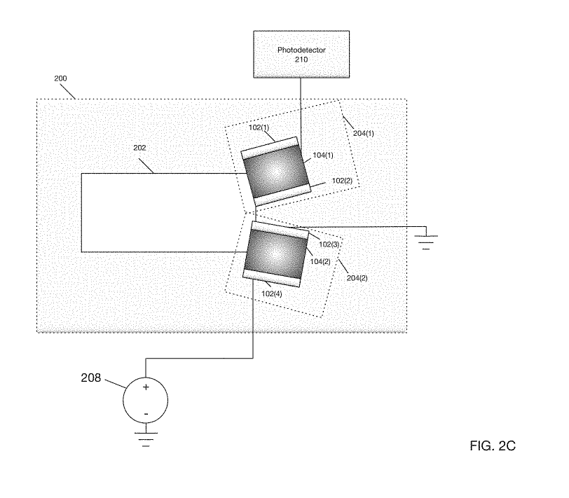

FIG. 2A depicts an optical test port incorporating an electrochromic material according to one embodiment. Electrochromic optical test port 200 comprises waveguide 202, testing portion 204(1) and transmission portion 204(2). Testing portion 204(1) comprises nanocrystal-in-glass material 104(1) and electrodes 102(1) and 102(2), which form a pair. Transmission portion 204(2) comprises nanocrystal-in-glass material 104(2) and electrodes 102(3) and 102(4), which form a pair. Testing portion 204(1) and transmission portion 204(2) are coupled to waveguide 202. As shown in FIG. 2A, the coupling is arranged through a Y-Junction. However, other arrangements are possible in other embodiments.

Upon arriving at the Y-Junction, a portion of light propagating through waveguide 200 will travel through transmission portion 204(2). As will become evident with respect to FIGS. 2B-2C, upon arriving at the Y-Junction, a portion of light propagating through waveguide 200 will travel through testing portion 204(1) depending upon whether a voltage is applied to electrodes 102(1) and 102(2). Electrodes 102(1)-102(4) may be made of indium tin oxide (ITO) or other conductive material suitable for optical applications. The light transmission through testing portion 204(1) may be measured by photodetector 210.

Electrochromic optical test port 200 provides a distinct advantage over convention optical test port methodologies such as those that utilize a tapered fiber approach in that it allows active tuning of the transmission properties of the testing portion 204(1) in relation to the transmission portion 204(2). This use of electrochromic material allows active tuning of the light transmission properties, which results in a higher signal-to-noise ratio (SNR) for induced light absorption when desired.

FIG. 2B depicts an optical test port incorporating an electrochromic material in which the test port is in an “off” state according to one embodiment. As shown in FIG. 2B, voltage source 208 is applied to electrode 102(1) of testing portion 204(1). In this configuration, nanocrystal-in-glass material 104(2) in transmission portion 204(2) does allow transmission of light from waveguide 202. However, in this configuration, nanocrystal-in-glass material 104(1) in testing portion 204(1) does not allow transmission of light from waveguide 202.

FIG. 2C depicts an optical test port incorporating an electrochromic material in which the test port is in an on state according to one embodiment. As shown in FIG. 2C, voltage source 208 is applied to electrode 102(1) of transmission portion 204(2) while electrode 102(2) of transmission portion 204(2) is grounded. In this configuration, nanocrystal-in-glass material 104(2) in transmission portion 204(2) allows transmission of a portion of the light from waveguide 202. In addition, in this configuration, nanocrystal-in-glass material 104(1) in testing portion 204(1) also allows transmission of a portion of the light from waveguide 202. The proportion of light passing through testing portion 204(1) relative to transmission portion 204(2) will depend upon the voltage applied to electrode 102(1). The light transmission through testing portion 204(1) may be measured by photodetector 210.

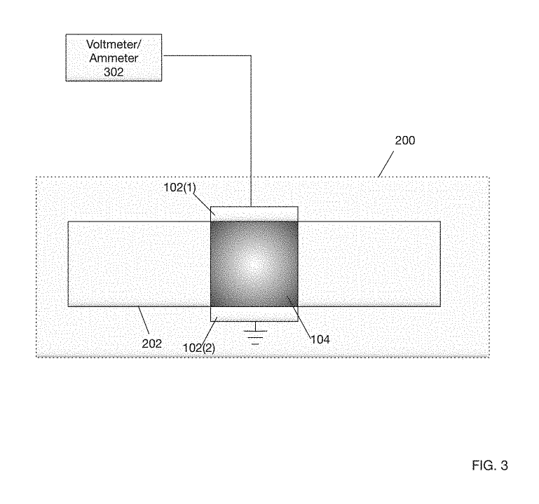

FIG. 3 depicts an alternative embodiment of an optical test port incorporating an electrochromic material in which an induced photo-voltage is utilized to monitor an optical transmission characteristic according to one embodiment. Electrochromic optical test port 200 comprises waveguide 202, electrode 102(1) and electrode 102(2) which form a pair, and nanocrystal-in-glass material 104. Further, as shown in FIG. 3, an ammeter or voltmeter 302 is applied to electrode 102(1). As an optical signal passes from waveguide 202 through nanocrystal-in-glass material 104, a small portion of the passing photons may be absorbed by nanocrystal-in-glass material 104 and converted to electrons, which generates a photo-current or photo-voltage that may be measured by ammeter/voltmeter 302 for diagnostic purposes. An advantage of the approach shown in FIG. 3 is that it does not require a splitting structure nor a photodetector, which thus yields a lower cost design.

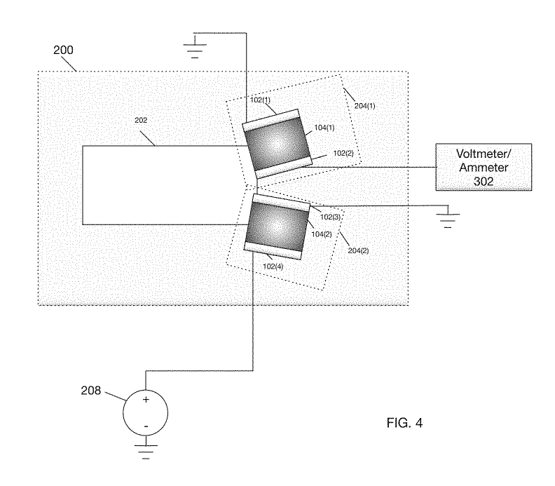

FIG. 4 depicts an optical test port incorporating an electrochromic material that combines a splitting structure and an induced photo-voltage measuring approach according to one embodiment. As shown in FIG. 4, rather than utilizing a photodetector as shown in the embodiment in FIG. 2A, voltmeter/ammeter 302 is coupled to electrode 102(2) while electrode 102(1) is grounded. Voltage source 208 coupled to electrode 102(4), which is coupled to nanocrystal-in-glass material 104(2) in transmission portion 204(2), allows modulation of light transmission through testing portion 204(1). As an optical signal passes from waveguide 202 through nanocrystal-in-glass material 104(1) in testing portion 204(1), a small portion of the passing photons may be absorbed by nanocrystal-in-glass material 104(1) and converted to electrons, which generates a current or voltage that may be measured by ammeter/voltmeter 302 coupled to electrode 102(2) for diagnostic purposes.

These and other advantages maybe realized in accordance with the specific embodiments described as well as other variations. It is to be understood that the above description is intended to be illustrative, and not restrictive. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” are used as the plain-English equivalents of the respective terms “comprising” and “wherein.” Moreover, in the following claims, the terms “first,” “second,” and “third,” etc. are used merely as labels, and are not intended to impose numerical requirements on their objects.

What is claimed is:

1. An optical test port for testing an optical waveguide comprising:
an electrochromic material coupled to the optical waveguide, said electrochromic material comprising a transmission portion and a testing portion;
at least one electrode coupled to the electrochromic material such that an optical transmission through at least one of the transmission portion and the testing portion is varied continuously based upon a voltage established on the at least one electrode; and
a photodetector coupled to the testing portion, the photodetector receiving a light signal from the testing portion.

2. The optical test port according to claim 1, wherein the at least one electrode comprises a first electrode and a second electrode, the first electrode coupled to the transmission portion and the second electrode coupled to the testing portion.

3. The optical test port according to claim 1, wherein the electrochromic material comprises a nanocrystal-in-glass material of nanocrystals covalently bonded in amorphous glass material.

4. The optical test port according to claim 1, wherein the optical transmission is dynamically controlled by varying a voltage source applied to the at least one electrode.

5. The optical test port according to claim 2, wherein the optical test port is turned off by applying a voltage source to the second electrode.

6. The optical test port according to claim 2, wherein the test port is turned on by applying a voltage source to the first electrode.

7. The optical test port according to claim 1, wherein the photodetector measures a light transmission property of the optical waveguide.

8. An optical test port for testing an optical waveguide comprising:
a nanocrystal-in-glass material coupled to the optical waveguide;
a first electrode and a second electrode coupled to the nanocrystal-in-glass material; and
a detector coupled to the first electrode for measuring electrons generated by absorbed photons passing through the nanocrystal-in-glass material.

9. The optical test port according to claim 8, wherein the detector is a voltmeter.

10. The optical test port according to claim 8, wherein the detector is an ammeter.

11. The optical test port according to claim 8, wherein the nanocrystal-in-glass material comprises nanocrystals covalently bonded in amorphous glass material.

12. The optical test port according to claim 8, wherein a photo-voltage is generated on the first electrode due to the generated electrons.

13. The optical test port according to claim 8, wherein a photo-current is generated at the first electrode due to the generated electrons.

14. An optical test port for testing an optical waveguide comprising:
a nanocrystal-in-glass material coupled to the optical waveguide, the nanocrystal-in-glass material comprising a transmission portion and a testing portion;
at least one electrode coupled to the nanocrystal-in-glass material such that an optical transmission through at least one of the transmission portion and the testing portion is varied continuously based upon a voltage established on the at least one electrode; and
a detector coupled to the testing portion, the detector measuring an electromagnetic property of the testing portion.

15. The optical test port according to claim 14, wherein the detector is a voltmeter.

16. The optical test port according to claim 14, wherein the detector is an ammeter.

17. The optical test port according to claim 14, wherein the nanocrystal-in-glass material comprises nanocrystals covalently bonded in amorphous glass material.

18. The optical test port according to claim 14, wherein a photo-voltage is generated on one of the at least one electrode due to the generated electrons.

19. The optical test port according to claim 14, wherein a photo-current is generated on one of the at the first electrode due to the generated electrons.

20. The optical test port according to claim 14, wherein the at least one electrode comprises a first electrode, a second electrode, a third electrode and a fourth electrode.
